(19) United States
(12) Patent Application Publication
(10) Pub. No.: US 2021/0390337 A1
(43) Pub. Date: Dec. 16, 2021

(54) PLAUSIBILIZATION OF THE OUTPUT OF AN IMAGE CLASSIFIER HAVING A GENERATOR FOR MODIFIED IMAGES

(71) Applicant: Robert Bosch GmbH, Stuttgart (DE)

(72) Inventor: Andres Mauricio Munoz Delgado, Weil Der Stadt (DE)

(21) Appl. No.: 17/334,110

(22) Filed: May 28, 2021

(30) Foreign Application Priority Data
Jun. 12, 2020 (DE) 102020207324.4

(51) Int. Cl. G06K 9/62

(52) U.S. Cl. CPC G06K 9/6231; G06K 9/627; G06K 2009/6237; G06K 9/623; G06K 9/6256

(57) ABSTRACT

A method for plausibilizing the output of an image classifier which assigns an input image to one or more class(es) of a predefined classification. The method includes: an assignment to one or more class(es) is ascertained for the input image using the image classifier; a relevance assessment function is used to ascertain a spatially resolved relevance assessment of the input image, which indicates which components of the input image have contributed to what degree to the assignment; a generator is trained to generate modifications of the input image that are as satisfactory as possible according to a predefined cost function in view of the optimization goals; based on the result of the training, and/or based on the modifications supplied by the trained generator, a quality measure for the spatially resolved relevance assessment, and/or a quality measure for the relevance assessment function is/are ascertained.

### CROSS REFERENCE

The present application claims the benefit under 35 U.S.C. § 119 of German Patent Application No. DE 102020207324.4 filed on Jun. 12, 2020, which is expressly incorporated herein by reference in its entirety.

### FIELD

The present invention relates to the control of the behavior of trainable image classifiers, which are able to be used for the quality control of mass-produced products, for example.

### BACKGROUND INFORMATION

In the mass production of products, it is usually necessary to check the quality of the production on a continual basis. The goal is to identify quality problems as rapidly as possible in order to be able to remedy the cause as quickly as possible and not to lose too many units of the respective product as waste.

The optical control of the geometry and/or the surface of a product is fast and does not result in destruction. PCT Patent Application No. WO 2018/197074 A1 describes a testing device in which an object can be exposed to a multitude of illumination situations, and a camera records images of the object in each of these illumination situations. The topography of the object is evaluated on the basis of these images.

With the aid of an image classifier, images of the product can also be directly assigned to one of multiple classes of a predefined classification on the basis of artificial neural networks. On that basis, the product is assignable to one of a plurality of predefined quality classes. In the simplest case, this classification is binary (“OK”/“not OK”).

### SUMMARY

Within the framework of the present invention, a method is provided for plausibilizing the output of an image classifier.

The image classifier assigns an input image to one or more class(es) of a predefined classification. For example, images of mass-produced and nominally identical products may be used as input images. The image classifier, for instance, is able to be trained to assign the input images to one or more of at least two possible class(es) that represent a quality assessment of the respective product.

For example, a product is able to be classified in a binary fashion as “OK” or “not OK” (NOK) based on an image. A subdivision into a classification that has more intermediate stages between “OK” and not OK”, for instance, may also be possible and useful.

In principle, the term ‘image’ encompasses any distribution of information arranged in a two- or multi-dimensional grid. This information, for instance, could be intensity values of image pixels which were recorded using any imaging modality such as an optical camera, a thermal image camera or by ultrasound. However, any other data such as audio data, radar data or LIDAR data are also able to be translated into images and then be classified in the same way.

In accordance with an example embodiment of the present invention, in the method, the image classifier is used to ascertain an assignment to one or more class(es) for a specific input image. Using a predefined relevance assessment function, a spatially resolved relevance assessment of the input image is ascertained. This spatially resolved relevance assessment indicates which components of the input image have contributed to the assignment to one or more class(es) and to what extent. For instance, it assigns to each pixel of the input image an intensity value which corresponds to the relevance for the class assignment, and which is therefore also referred to as a heat map.

Then, a generator is trained to generate modifications of the input image that are as satisfactory as possible according to a predefined cost function with regard to the optimization goals so that
on the one hand, they are changed as little as possible in a component that the relevance assessment function classified as less relevant for the class assignment, and
on the other hand, they are given a different classification by the image classifier than the input image.

The desire for the slightest possible modification in the less relevant component may manifest itself in this cost function as the norm across the change in the less relevant component. The desire for a change in the classification is able to be incorporated into the cost function by a random measure for the difference between the class assignments, the class assignments possibly also being vectors, for example. If the class assignments involve discrete, categorical variables, then the difference is able to be measured in particular using a (binary) cross entropy. In the case of continual variables, on the other hand, a mean squared deviation may be ascertained, for example.

The generator ideally supplies modifications of the input image that have been changed in comparison with the input image only in the particular locations that were previously assessed as relevant for the class assignment by the spatially resolved relevance assessment. If this relevance assessment is correct, then this means in the reverse conclusion that the class assignment may be changed by changing the input image in precisely the relevant areas.

The combining of the mentioned optimization goals in a cost function allows for random weighting of the optimization goals against one another. In particular, hard marginal conditions that could lead to the creation of unrealistic artefacts in the modifications are able to be avoided. Thus, for example, it is possible that a modification that the image classifier has classified quite differently than the input image may in turn be allowed the “blunder” of changing also a few less relevant pixels of the input pixel.

However, the demand that the component of the input image classified as less relevant be changed as little as possible then still causes the generator to specifically learn the generation of modifications of the input image that are realistic with regard to the specific application. For example, the fact that the class assignment of the input image is able to be modified by inserting an artificial pixel pattern that is not to be expected in real camera images makes it quite difficult to derive a statement that is helpful for the mentioned optical quality control. On the other hand, if the modification makes a tear or some other defect disappear that is visible in the input image and one could imagine it as a real camera image of a product without deficiencies, then a change in class from “not OK” to “OK” indicates that the image classifier utilizes precisely the right image areas for the quality assessment.

Based on the result of the training and/or based on the modifications supplied by the trained generator, a quality measure for the spatially resolved relevance assessment and/or a quality measure for the relevance assessment function that forms the basis of this relevance assessment is/are ascertained.

The relevance assessment function is specific to the respective application of the image classifier. The spatially resolved relevance assessment it provides is able to be used in a wide variety of ways for plausibilizing the output of the image classifier with regard to this application.

For example, in the quality control of mass-produced products, a random check is able to be carried out for certain combinations of an input image and an assignment to ascertain whether a deficiency or damage that is meant to result in this quality assessment according to the specification of the specific application has actually led to the decision to mark a product by the quality assessment “not OK”.

If the image classifier is used for detecting objects, then the spatially resolved relevance assessment may be utilized to check whether only image areas that actually belong to this object have contributed to the detection of a certain object. For example, if an input image has been classified as showing a motor vehicle but this decision was made based on image areas showing a tree, for instance, then this assignment will not be at all comprehensible. Even if the image actually shows a motor vehicle at another location, it is quintessentially still the case that image areas showing a tree have erroneously been classified as a motor vehicle. In complex sceneries featuring a multitude of objects, it must therefore be expected that the total number of objects detected in an image of the scene ultimately does not match the number of objects that can actually be found in the scene.

The evaluation of the spatially resolved relevance assessment shown here as a check of a random sample may also be carried out in some other fashion by a machine so that a 100% control of all assignments output by the image classifier is able to be realized.

However, the trustworthiness of such a control depends to a decisive degree on whether the relevance assessment function is applicable to the respective application. Many such relevance assessment functions developed for certain applications are known from the literature. However, a mathematical guarantee that a specific relevance assessment function is correct for a specific application does not exist a priori.

In accordance with an example embodiment of the present invention, the quantitative quality measure ascertained according to the present method makes it possible to validate a randomly specified relevance assessment function as appropriate for a specifically provided application. This particularly makes it possible to select the relevance assessment function more from the aspect of the required computing time. Here, the wish for high efficiency with regard to computing time on the one hand and an easy interpretability on the other hand are clashing objectives in many instances. For that reason, a few relevance assessment functions to be calculated with high efficiency went unused until now simply because it could not be guaranteed with sufficient reliability that they were suitable for the specific application. However, high efficiency is important, especially in the quality control of mass-produced products, so that the computing time required for each product for the quality control still strikes an acceptable balance with the required time for the actual production of the product. The quality measure thus ultimately allows for an acceleration of the continual control of the behavior of the image classifier, and thus also an acceleration of the quality control as a whole.

As will be described in greater detail in the following text, the modifications of the input image generated with the aid of the present method are an important and directly interpretable source of information on their own by which the behavior of the image classifier is able to be explained and and the training of the image classifier improved.

In accordance with an example embodiment of the present invention, the present method objectifies the control as to whether the image classifier utilizes the areas for the class assignment that are actually relevant from the aspect of the application. In contrast to a visual control, the present method will not be “deceived” by the fact that less relevant features in the input image are possibly reproduced with greater contrast or in a better form in terms of quality. For example, a tear that can be seen very well in the input image may be situated at a location of the product that is not critical for the mechanical sturdiness of the product. Such a tear is of lesser importance for the quality of the product. On the other hand, a tear that can be detected only with difficulties in the input image may be situated in an area from where it can propagate further when subjected to mechanical loading and ultimately lead to the failure of the product. Such a tear is of great importance for the quality of the product.

In accordance with an example embodiment of the present invention, the generator may particularly be developed to translate inputs z from an input space into modifications that belong to the space of the input images. The input space may especially have the same dimensionality as the space of the input images, i.e. inputs z may have the same pixel resolution as the input images. This is not mandatory, however. Parameters that characterize the behavior of the generator are able to be optimized with the goal of improving the modifications then supplied by the generator with regard to the mentioned optimization goals. A random parameter optimization method may be used for an optimization of this type such as ADAM or a gradient descent method. For gradient-based methods, it is merely important that the cost function be differentiable according to the parameters of the generator. In addition, however, there are also gradient-free optimization algorithms such as genetic algorithms. These algorithms do not presuppose a differentiable generator.

Inputs z may be drawn from Gaussian noise or from some other random distribution, for example. However, they can also be a subject of the optimization. The result of the optimization then is a pair made up of an optimal generator and an optimal input z* in relation to a specific input image.

In one particularly advantageous embodiment of the present invention, further modifications are able to be ascertained starting from optimal parameters and optionally also starting from an optimal input z*, this being accomplished by
drawing parameters from a random distribution around the optimum; and/or
repeating the optimization of the parameters starting from other starting values.

Summarizing statistics are able to be determined for an ensemble of modifications obtained in this manner. Such statistics in turn may become part of the quality measure for the relevance assessment or of the quality measure for the relevance assessment function.

In a further, particularly advantageous embodiment of the present invention, the optimization goal that the image classifier assign a different classification to the modifications than to the input image versus the optimization goal that the component classified as less relevant for the class assignment be modified as little as possible is weighted just high enough so that the image classifier does classify the modifications differently than the input image. For instance, the cost function may include a sum of two terms that relate to both optimization goals. The relative weighting of both terms against each other is able to be adjusted via a linear parameter, for example. In addition, the training may also focus on ensuring in varies ways that the solutions output by the generator are realistic, e.g., using further terms in the cost function or by specifying marginal conditions during the training. In this way, “adversarial examples”, for instance, are able to be excluded as solutions.

If the term to which the class assignment relates is weighted only to the required extent, then this creates a greater incentive for the optimization to pay attention to ensuring that only the areas of the input image are modified that are classified as relevant, if possible.

In another, particularly advantageous embodiment of the present invention, in the modifications supplied by the generator, changes in the component of the input image that were classified as less relevant for the class assignment by the relevance assessment function are retroactively suppressed. This ensures that the change in the class assignment caused by the modification is brought about solely by changes in the component of the input image that was assessed as more relevant in the spatially resolved relevance assessment.

As mentioned above, the generator is trained for a specific input image, in particular. The generator thus has to be trained anew for a new input image. Especially in the quality control of mass-produced products, however, the input images are nominally very similar. For that reason, the generator in another particularly advantageous further embodiment is able to be trained with regard to an input image starting from a generator already trained for an earlier input image. If an input z was also optimized for the previously trained generator, then the optimized input z* may also be used as starting point for the optimization of new input z in the new training. In other words, a large portion of the previously completed training can be reused. The training of always new generators for always new input images may then no longer be carried out only in the course of the validation of a relevance assessment function, but become fast enough to be continued also during the ongoing quality control.

The subdivision of the input image into a component that is less relevant for the class assignment and into a component that is more relevant for the class assignment may be carried out in a fluid manner, e.g., at a steadily variable relevance measure that is assigned to each pixel of the input image. In one especially advantageous embodiment of the present invention, however, based on a comparison of the spatially resolved relevance assessment with a predefined threshold value, the input image is subdivided in a binary fashion into a less relevant component for the class assignment and into a more relevant component for the class assignment. In each case, these components may then be ascertained from the input image by an elementwise multiplication with binary masks and processed en bloc in an especially rapid manner by further matrix operations. The further calculations with these components then benefit in particular from acceleration mechanisms, for example, and the multiplications in which a factor is zero are able to be omitted completely.

It is not guaranteed that the training of the generator leads to modifications that are given a different classification by the image classifier than the input image in each case. For instance, if a product has multiple deficiencies or damage of which each one, taken by itself, already leads to the “not OK” quality assessment for the product, then the image classifier may preferably “home in on” the particular deficiency or damage that is most easily detectable in the input image. It is then a correct statement that this deficiency or damage was the cause of the quality judgment “not OK”. If a modification is then generated that specifically makes this deficiency or damage disappear, the next deficiency or damage may become dominant and cause the modification to continue to be classified as “not OK”.

This will not change regardless of how intensive and excellent the training of the generator is because the previous specification according to which especially the first deficiency or damage is relevant narrows the change in the modification to precisely this point.

The same may happen when pedestrians are detected. Here, the detection of the image classifier may “home in on” the face, for instance, but the pedestrian is still able to be identified as such in the modification on the basis of his or her arms, legs or the torso even after the face has been removed.

Thus, if the generator supplies modifications that are still assigned to the same class(es) as the input image even after the training has been concluded, then this may be an indication that the component of the input image that is more relevant according to the spatially resolved relevance assessment does not yet detect the complete information that supports the original class assignment of the input image.

In accordance with an example embodiment of the present invention, in order to also detect the remaining information supporting this class assignment, the method is able to be started anew in an iterative manner, for example, in which case the modification now serves as the input image. In the mentioned quality control example, it is thus the area featuring the mentioned further deficiency or damage that will then be classified as relevant for the class assignment, and the new generator then works towards removing precisely this deficiency or damage.

In accordance with an example embodiment of the present invention, as an alternative or in combination therewith, the mentioned threshold value for the binary subdivision of the input image into a less relevant and a more relevant component may then also be modified to the effect that a larger component of the input image is deemed relevant. The present method is then able to be started anew using this threshold value.

Based on the relevance assessment function, and/or based on the quality measure of this relevance assessment function, and/or based on the spatially resolved relevance assessment, and/or based on the quality measure of this spatially resolved relevance assessment, a plausibility of the output of the image classifier is able to be evaluated. This plausibility is based on a quantitatively motivated basis and depends on the concrete input image. Thus, it is particularly possible to detect also input images for which it is doubtful whether the image classifier makes the decision about the class assignment on the basis of the information that is correct within the context of the application. For example, if an image recorded for the quality control of a product is blurry, unfocused or incorrectly exposed, then the image classifier may “alternatively” utilize features of the image background for its decision.

In a further, especially advantageous example embodiment of the present invention, in response to the ascertained plausibility satisfying a predefined criterion, a product to which the input image relates is marked for a manual follow-up check, and/or a conveyor device is actuated in order to separate this product from the production process. This is so because a considerable additional technical effort for the recording and evaluation of images in the framework of the automated quality control can then be saved that would otherwise be necessary to also allow for an automated clarification of all doubtful cases and borderline cases. The manual follow-up check of a few items of a product produced in large batch numbers may be economically much more advantageous than increasing the hit rate in the automated quality control to a measure that would completely remove all doubtful cases to be rechecked later.

In a further, particularly advantageous embodiment of the present invention, at least one modification supplied by the generator is used as a further training image for the image classifier. Starting from the original input image, the modification exceeds the decision limit of the image classifier. When the modification is used as a training image, the decision limit of the image classifier is able to be further tightened.

The present method may particularly be partly or fully implemented by a computer. For that reason, the present invention also relates to a computer program having machine-readable instructions that—when carried out on a computer or on multiple computers—induce the computer(s) to execute the described method. In this sense, control units for vehicles and embedded systems for technical devices that are likewise able to carry out machine-readable instructions should also be considered computers.

In the same way, the present invention also relates to a machine-readable data carrier and/or to a download product having the computer program. A download product is a downloadable, digital product that is transmittable via a data network, i.e., downloadable by a user of the data network, and may be offered by an online shop for an immediate download, for instance.

In addition, a computer having the computer program is able to be equipped with the machine-readable data carrier or with the download product.

Additional measures that improve the present invention will be shown in greater detail in the below together with the description of the preferred exemplary embodiments of the present invention with the aid of the figures.

### BRIEF DESCRIPTION OF THE DRAWINGS

FIG. 1 shows an exemplary embodiment of method 100 in accordance with an example embodiment of the present invention.

FIG. 2 an example of an iterative generation of modifications 7 of an input image 1 until a change in the class assignment has been achieved, in accordance with an example embodiment of the present invention.

### DETAILED DESCRIPTION OF EXAMPLE EMBODIMENTS

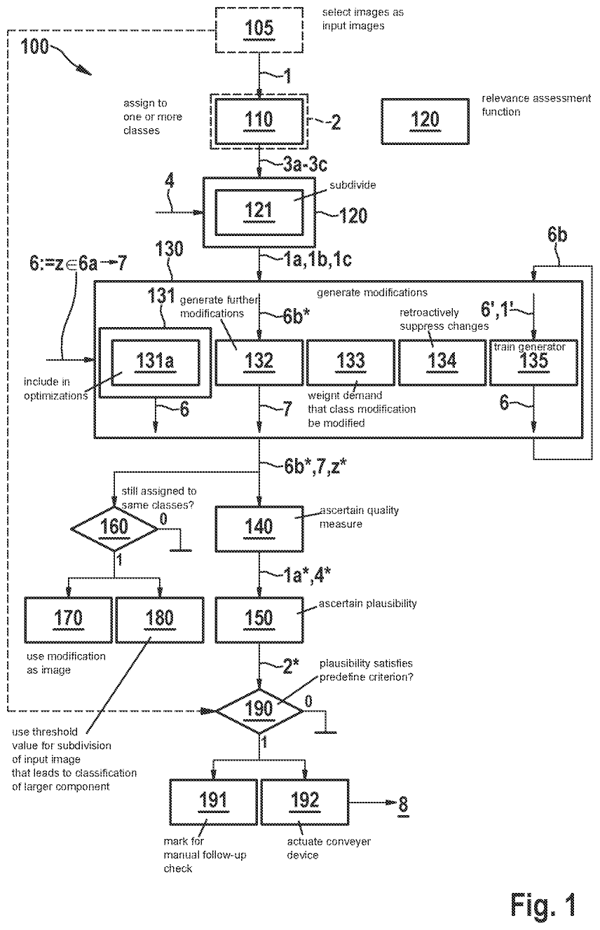

FIG. 1 is a schematic flow chart of an exemplary embodiment of method 100 for plausibilizing the output of an image classifier 2, which assigns an input image 1 to one or more class(es) 3a-3c of a predefined classification. For instance, according to step 105, in particular images of mass-produced, nominally identical products are able to be selected as input images 1. Image classifier 2 may then be trainable to subdivide input images 1 into classes 3a-3c of a predefined classification that represent a quality assessment of the respective product.

In step 110, an assignment to one or more class(es) 3a-3c is ascertained for input image 1 with the aid of image classifier 2. In step 120, a relevance assessment function 4 is used to ascertain a spatially resolved relevance assessment 1a of input image 1. This relevance assessment 1a indicates which components 1b, 1c of input image 1 have contributed to what degree to the assignment to one or more class(es) 3a-3c.

In step 130, a generator 6 is trained to generate modifications 7 of input image 1 which are as satisfactory as possible according to the specification of a predefined cost function in view of two optimization goals. On the one hand, modifications 7 should be changed as little as possible in component 1b of input image 1 classified as less relevant for the class assignment by relevance assessment function 4. On the other hand, modifications 7 should be given a different classification by image classifier 2 than input image 1. According to block 131, in particular, generator 6 can provide a translation of inputs z from an input space 6a into modifications 7.

The training of generator 6 includes an optimization of parameters 6b that characterize the behavior of generator 6 so that modifications 7 supplied by generator 6 come as close as possible to the mentioned optimization goals. The result of this training is the fully trained state 6b* of parameters 6b. According to block 131a, in the example shown in FIG. 1, input z is also included in the optimization, and an optimized state z* of input z is created at the end of the training.

According to block 132, starting from optimal parameters 6b*, it is possible to generate still further modifications 7 for one and the same input image 1. As described above, a revealing statistic is able to be set up via such an ensemble of modifications 7.

The demand that the class assignment be modified may be weighted to precisely such a degree according to block 133 that such a change does actually take place. As previously mentioned, the optimization is thereby not diverted from the further goal of not changing component 1b of input image 1 assessed as less relevant, if possible. Possible changes in this component 1b of input image 1 are able to be retroactively suppressed according to block 134.

According to block 135, generator 6 is able to be trained starting from a generator 6′ already trained for an earlier input image 1′. As previously described, it is then possible to save computing time, in particular within the framework of a quality control of mass-produced products in which many nominally similar input images 1 are created.

In step 140, based on the result of training 130, and/or based on modifications 7 supplied by trained generator 6, a quality measure 1a* for spatially resolved relevance assessment 1a and/or a quality measure 4* for relevance assessment function 4 is/are ascertained. On that basis, in step 150, plausibility 2* of the output of image classifier 2 in relation to concrete input image 1 is in turn able to be ascertained.

In step 190, it is checked whether this plausibility 2* satisfies a predefined criterion. If this is the case (truth value 1), the product to which input image 1 relates is able to be marked for a manual follow-up check in step 191, for example. As an alternative or also in combination therewith, a conveyer device 8 is able to be actuated in step 192 in order to separate this product from the production process.

However, training 130, for instance, may also lead to the result that generator 6 still supplies modifications 7 that are still assigned to the same class(es) 3a-3c as input image 1 even after the conclusion of training 130. If this is the case (truth value 1 in respective check 160), then it is possible that a few but not all components 1c of the input image relevant for the class assignments were identified so far. According to block 170, method 100 is then able to be started anew using such a modification 7 as input image 1. Alternatively or also in combination therewith, according to block 180, the method may be started anew using a threshold value for the subdivision of input image 1 that leads to the classification of a larger component 1c of input image 1 as relevant for the class assignment.

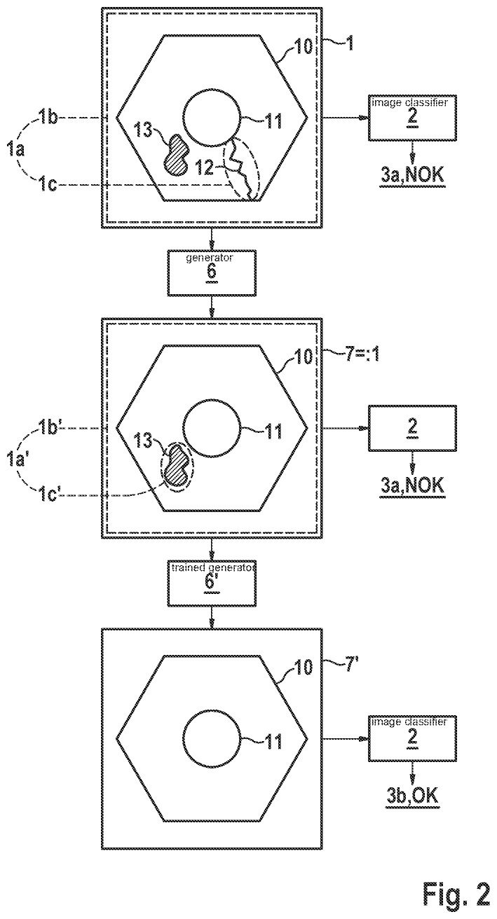

FIG. 2 shows an exemplary development of an input image 1 in an iterative execution of method 100. Input image 1 shows a screw nut 10 having an inner thread 11 in the center. This screw nut has two defects, more specifically, a tear 12, which extends from the outer circumference of inner thread 11 to the outer edge of screw nut 10, as well as a material accumulation 13. Accordingly, image classifier 2 assigns class 3a to input image 1, which corresponds to quality assessment “not OK” (NOK). Spatially resolved relevance assessment 1a of input image 1 makes it clear that area 1c featuring tear 12 was classified as relevant for the assignment to class 3a, while the rest 1b of input image 1 is considered to be of lesser relevance.

Generator 6 is trained toward the goal of making changes in area 1b of input image 1 so that a modification 7 is produced. This modification 7 is to be of such a nature that image classifier 2 assigns it to class 3b, which corresponds to quality assessment “OK”.

In the example shown in FIG. 2, tear 12 has indeed disappeared in modification 7, but modification 7 is still assigned to class 3a for “not OK” by image classifier 2. The new, spatially resolved relevance assessment 1a′ reveals the cause for this: Area 1c′ with material accumulation 13 is now decisive for the class assignment.

The decision between classes 3a “not OK” and 3b “OK” thus depends on more than only the initially identified tear 12. The hypothesis that area 1c′ with material accumulation 13 is also important in this context is checked with the aid of a second generator 6′ to which modification 7 is supplied as input image 1. Second generator 6′ is trained to make changes in in the most recently identified area 1c′ featuring material accumulation 13, with the goal that the thereby created modification 7′ will be assigned to class 3b for “OK” by image classifier 2.

As illustrated in FIG. 2, this is accomplished in that second generator 6′ now also removes material accumulation 13 in new modification 7′.

Example embodiments of the present invention are also set forth in the numbered Paragraphs below.

Paragraph 1. A method (100) for plausibilizing the output of an image classifier (2) which assigns an input image (1) to one or more class(es) (3a-3c) of a predefined classification, the method having the steps:
An assignment to one or more class(es) (3a-3c) is ascertained (110) for the input image (1) with the aid of the image classifier (2);
A relevance assessment function 4 is used to ascertain (120) a spatially resolved relevance assessment (1a) of the input image (1) which indicates which components (1b, 1c) of the input image have contributed to what degree to the assignment to one or more class(es) (3a-3c);
A generator (6) is trained (130) to generate modifications (7) of the input image (1) that are as satisfactory as possible according to the specification of a predefined coast function in view of the optimization goals according to which
   on the one hand, they are changed as little as possible in a component (1b) classified as less relevant for the class assignment by the relevance assessment function (4); and
   on the other hand, they are given a different classification by the image classifier (2) than the input image (1);
based on the result of the training (130), and/or based on the modifications (7) supplied by the trained generator (6), a quality measure (1a*) for the spatially resolved relevance assessment (1a) and/or a quality measure (4*) for the relevance assessment function (4) is/are ascertained (140).

Paragraph 2. The method as recited in Paragraph 1, wherein a generator (6) is selected (131) which is developed to translate inputs z from an input space (6a) into modifications (7), and parameters (6b) which characterize the behavior of the generator (6) are optimized with regard to the optimization goals for the modifications (7).

Paragraph 3. The method (100) as recited in Paragraph 2, wherein the inputs z are additionally optimized (131a) with regard to the optimization goals for the modifications (7).

Paragraph 4. The method (100) as recited in one of Paragraphs 2 to 3, wherein further modifications (7) are ascertained (132) starting from optimal parameters (6b*) in that
parameters (6b) are drawn from a random distribution around the optimum (6b*); and/or
the optimization of the parameters (6b) is repeated starting from different starting values.

Paragraph 5. The method (100) as recited in one of Paragraphs 1 through 4,

wherein the optimization goal that the image classifier (2) assign a different classification to the modifications (7) than to the input image (1) versus the optimization goal that the component (1b) classified as less relevant for the class assignment be modified as little as possible is weighted (133) just high enough so that the image classifier (2) does actually classify the modifications (7) differently than the input image (1)

Paragraph 6. The method (100) as recited in one of Paragraphs 1 through 5, wherein in the modification (7) supplied by the generator (6), changes in the component (1b) of the input image (1) that were classified as less relevant for the class assignment by the relevance assessment function (4) are retroactively suppressed (134).

Paragraph 7. The method (100) as recited in one of Paragraphs 1 through 6,

wherein the generator (6) is trained (135) with regard to an input image (1) starting from a generator (6′) already trained for an earlier input image (1′).

Paragraph 8. The method (100) as recited in one of Paragraphs 1 through 7, wherein based on a comparison of the spatially resolved relevance assessment (1a) with a predefined threshold, the input image (1) is subdivided (121) in a binary fashion into a less relevant component (1b) for the class assignment and into a more relevant component (1c) for the class assignment.

Paragraph 9. The method (100) as recited in one of Paragraphs 1 through 8, wherein in response to the generator (6) supplying (160) modifications (7) that are still assigned to the same class(es) (3a-3c) as the input image (1) after the training (130) has been concluded,
the method (100) is started anew (170) using such a modification (7) as the input image (1), and/or
the method (100) is started anew (180) using a threshold value for the subdivision of the input image (1) that leads to the classification of a larger component (1c) of the input image (1) as more relevant for the class assignment.

Paragraph 10. The method (100) as recited in one of Paragraphs 1 through 9, wherein based on the relevance assessment function (4), and/or based on the quality measure (4*) of this relevance assessment function (4), and/or based on the spatially resolved relevance assessment (1a), and/or based on the quality measure (1a*) of this spatially resolved relevance assessment (1a), a plausibility (2*) of the output of the image classifier (2) is evaluated (150).

Paragraph 11. The method (100) as recited in Paragraph 10, wherein in response to the ascertained plausibility (2*) satisfying a predefined criterion (190), a product to which the input image (1) relates is marked for a manual follow-up (191), and/or a conveyor device (8) is actuated (192) in order to separate this product from the production process.

Paragraph 12. The method as recited in one of Paragraphs 1 through 11, wherein at least one modification (7) supplied by the generator (6) is used as a further training image for the image classifier (2).

Paragraph 13. The method (100) as recited in one of Paragraphs 1 through 12, wherein images of mass-produced, nominally identical products are selected (105) as input images (1), and the image classifier (2) is trained to assign the input images (2a-3c) to one or more of at least two possible class(es) (3a-3c) which represent a quality assessment of the respective product in each case.

Paragraph 14. A computer program including machine-readable instructions that, when executed on a computer or multiple computers, induce the computer(s) to execute the method (100) as recited in one of Paragraphs 1 through 13.

Paragraph 15. A machine-readable data carrier and/or download product including the computer program as recited in Paragraph 14.

Paragraph 16. A computer, equipped with the computer program as recited in Paragraph 14, and/or with the machine-readable data carrier and/or the download product as recited in Paragraph 15.

What is claimed is:

1. A method for plausibilizing an output of an image classifier which assigns an input image to one or more classes of a predefined classification, the method comprising the following steps:
ascertaining an assignment to one or more classes for the input image using the image classifier;
ascertaining, using a relevance assessment function, a spatially resolved relevance assessment of the input image which indicates which components of the input image have contributed to what degree to the assignment to the one or more classes;
training a generator to generate modifications of the input image that are as satisfactory as possible according to a specification of a predefined cost function in view of optimization goals according to which:
on the one hand, the modifications modify as little as possible a component of the input image classified as less relevant for the class assignment by the relevance assessment function, and
on the other hand, the modifications are given a different classification by the image classifier than the input image;
based on a result of the training, and/or based on the modifications supplied by the trained generator, ascertaining a quality measure for the spatially resolved relevance assessment and/or a quality measure for the relevance assessment function.

2. The method as recited in claim 1, wherein the generator translates inputs from an input space into the modifications, and parameters which characterize a behavior of the generator are optimized with regard to the optimization goals for the modifications.

3. The method as recited in claim 2, wherein the inputs are additionally optimized with regard to the optimization goals for the modifications.

4. The method as recited in claim 2, wherein further modifications are ascertained starting from optimal parameters in that:
the parameters are drawn from a random distribution around an optimum; and/or
the optimization of the parameters is repeated starting from different starting values.

5. The method as recited in claim 1, wherein the optimization goal that the image classifier assign a different classification to the modifications than to the input image versus the optimization goal that the component classified as less relevant for the class assignment be modified as little as possible is weighted just high enough so that the image classifier does actually classify the modifications differently than the input image.

6. The method as recited in claim 1, wherein in the modifications supplied by the generator, changes in a component of the input image that were classified as less relevant for the class assignment by the relevance assessment function are retroactively suppressed.

7. The method as recited in claim 1, wherein the generator is trained with regard to an input image starting from a generator already trained for an earlier input image.

8. The method as recited in claim 1, wherein based on a comparison of the spatially resolved relevance assessment with a predefined threshold, the input image is subdivided in a binary fashion into a less relevant component for the class assignment and into a more relevant component for the class assignment.

9. The method as recited in claim 8, wherein in response to the generator supplying modifications that are still assigned to the same class(es) as the input image after the training has been concluded:
the method is started anew using such the supplied modifications as the input image, and/or
the method is started anew using a threshold value for the subdivision of the input image that leads to the classification of a larger component of the input image as more relevant for the class assignment.

10. The method as recited in claim 1, wherein based on the relevance assessment function, and/or based on the quality measure of the relevance assessment function, and/or based on the spatially resolved relevance assessment, and/or based on the quality measure of the spatially resolved relevance assessment, a plausibility of the output of the image classifier is evaluated.

11. The method as recited in claim 10, wherein in response to the ascertained plausibility satisfying a predefined criterion, a product to which the input image relates is marked for a manual follow-up, and/or a conveyor device is actuated in order to separate this product from the production process.

12. The method as recited in claim 1, wherein at least one of the modifications supplied by the generator is used as a further training image for the image classifier.

13. The method as recited in claim 1, wherein images of mass-produced, nominally identical products are selected as the input images, and the image classifier is trained to assign the input images to one or more of at least two possible classes which represent a quality assessment of the respective product in each case.

14. A non-transitory machine-readable data carrier on which is stored a computer program for plausibilizing an output of an image classifier which assigns an input image to one or more classes of a predefined classification, the computer program, when executed by one or more computers, causing the one or more computers to perform the following steps:
ascertaining an assignment to one or more classes for the input image using the image classifier;
ascertaining, using a relevance assessment function, a spatially resolved relevance assessment of the input image which indicates which components of the input image have contributed to what degree to the assignment to the one or more classes;
training a generator to generate modifications of the input image that are as satisfactory as possible according to a specification of a predefined cost function in view of optimization goals according to which:
on the one hand, the modifications modify as little as possible a component of the input image classified as less relevant for the class assignment by the relevance assessment function, and
on the other hand, the modifications are given a different classification by the image classifier than the input image;
based on a result of the training, and/or based on the modifications supplied by the trained generator, ascertaining a quality measure for the spatially resolved relevance assessment and/or a quality measure for the relevance assessment function.

15. A computer configured for plausibilizing an output of an image classifier which assigns an input image to one or more classes of a predefined classification, the computer configured to:
ascertain an assignment to one or more classes for the input image using the image classifier;
ascertain, using a relevance assessment function, a spatially resolved relevance assessment of the input image which indicates which components of the input image have contributed to what degree to the assignment to the one or more classes;
train a generator to generate modifications of the input image that are as satisfactory as possible according to a specification of a predefined cost function in view of optimization goals according to which:
on the one hand, the modifications modify as little as possible a component of the input image classified as less relevant for the class assignment by the relevance assessment function, and
on the other hand, the modifications are given a different classification by the image classifier than the input image;
based on a result of the training, and/or based on the modifications supplied by the trained generator, ascertain a quality measure for the spatially resolved relevance assessment and/or a quality measure for the relevance assessment function.
